(19) United States
(12) Patent Application Publication
(10) Pub. No.: US 2024/0250521 A1
(43) Pub. Date: Jul. 25, 2024

(54) POWER SUPPLY CONTROL DEVICE AND POWER SUPPLY CONTROL METHOD

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Kota ODA, Yokkaich-shi, Mie (JP); Koki SAKAKIBARA, Yokkaichi-shi, Mie (JP); Masaya INA, Yokkaichi-shi, Mie (JP)

(21) Appl. No.: 18/566,309

(22) PCT Filed: May 17, 2022
(86) PCT No.: PCT/JP2022/020465

§ 371 Date: Dec. 1, 2023

(30) Foreign Application Priority Data
Jun. 3, 2021 (JP) 2021-093647

(51) Int. Cl. H02H 7/20; H02J 1/00

(52) U.S. Cl. CPC H02H 7/20; H02J 1/00

(57) ABSTRACT

An ECU controls the supply of power to a load. An upstream switch and a downstream switch are respectively arranged upstream and downstream of the load in a current path of the flow of current through the load. A control unit of a microcomputer determines whether or not current is flowing through the upstream switch while an instruction to switch OFF the upstream switch has been given. If it was determined that current is flowing through the upstream switch, the control unit gives an instruction to switch OFF the downstream switch.

### CROSS-REFERENCE TO RELATED APPLICATIONS

This application is the U.S. national stage of PCT/JP2022/020465 filed on May 17, 2022, which claims priority of Japanese Patent Application No. JP 2021-093647 filed on Jun. 3, 2021, the contents of which are incorporated herein.

### TECHNICAL FIELD

The present disclosure relates to a power supply control device and a power supply control method.

### BACKGROUND

JP 2019-41508A discloses a power supply control device for a vehicle that controls the supply of power from a DC power supply to a load. A switch is disposed in the current path of the current that flows from the DC power supply to the load. The control device controls the supply of power to the load by giving an instruction for the switch to be switched on or off.

In the configuration disclosed in JP 2019-41508A, if a short-circuit failure occurs in a switch, that is to say if current flows through the switch even though the control device has given an instruction to switch OFF the switch, the DC power supply continues to supply power to the load. In this case, power from the DC power supply may be needlessly consumed.

The present disclosure has been made in view of such circumstances, and an object of the present disclosure is to provide a power supply control device and a power supply control method capable of stopping the supply of power to a load when a short-circuit failure occurs.

### SUMMARY

A power supply control device according to an aspect of the present disclosure is a power supply control device that controls a supply of power to a load, including: an upstream switch configured to be arranged upstream of the load in a current path of a flow of current through the load; a downstream switch configured to be arranged downstream of the load in the current path; and a processing unit configured to execute processing, wherein the processing unit gives an instruction to switch ON or OFF a first switch that is either one of the upstream switch and the downstream switch, the processing unit determines whether or not current is flowing through the first switch while an instruction to switch OFF the first switch has been given, and in a case of determining that current is flowing through the first switch, the processing unit gives an instruction to switch OFF a second switch that is another one of the upstream switch and the downstream switch.

A power supply control method according to an aspect of the present disclosure is a power supply control method of controlling a supply of power to a load, the power supply control method causing a computer to execute the steps of: giving an instruction to switch ON or OFF a first switch that is either one of an upstream switch arranged upstream of the load in a current path of a flow of current through the load and a downstream switch arranged downstream of the load in the current path; determining whether or not current is flowing through the first switch while an instruction to switch OFF the first switch has been given; and giving an instruction to switch OFF a second switch that is another one of the upstream switch and the downstream switch in a case where a determination was made that current is flowing through the first switch.

Note that the present disclosure can be realized not only as a power supply control device including such a characteristic processing unit, but also as a power supply control method having such characteristic processing as steps, or a computer program for causing a computer to execute such steps. Also, the present disclosure can be implemented as a semiconductor integrated circuit that implements part or all of the power supply control device, or as a power supply control system that includes the power supply control device.

### ADVANTAGEOUS EFFECTS

According to the above aspect, the supply of power to a load can be stopped when a short-circuit failure occurs.

### BRIEF DESCRIPTION OF DRAWINGS

FIG. 1 is a block diagram showing a configuration of a relevant portion of a power supply system according to a first embodiment.

FIG. 2 is a block diagram showing a configuration of a relevant portion of an ECU.

FIG. 3 is a block diagram showing a configuration of a relevant portion of a microcomputer.

FIG. 4 is a flowchart showing a procedure of write processing.

FIG. 5 is a flowchart showing a procedure of transmission processing.

FIG. 6 is a flowchart showing a procedure of downstream switch control processing.

FIG. 7 is a flowchart showing a procedure of power supply control processing.

FIG. 8 is a timing chart for describing effects of the ECU.

FIG. 9 is a block diagram showing a configuration of a relevant portion of an ECU according to a second embodiment.

FIG. 10 is a block diagram showing a configuration of a relevant portion of an ECU according to a third embodiment.

FIG. 11 is a block diagram showing a configuration of a relevant portion of a power supply system according to a fourth embodiment.

FIG. 12 is a block diagram showing a configuration of a relevant portion of an ECU.

FIG. 13 is a block diagram showing a configuration of a relevant portion of a microcomputer.

FIG. 14 is a block diagram showing a configuration of a relevant portion of an ECU according to a fifth embodiment.

### DETAILED DESCRIPTION OF PREFERRED EMBODIMENTS

First, embodiments of the present disclosure will be listed and described. At least portions of the embodiments described below may be combined as desired.

A power supply control device according to an aspect of the present disclosure is a power supply control device that controls a supply of power to a load, including: an upstream switch configured to be arranged upstream of the load in a current path of a flow of current through the load; a downstream switch configured to be arranged downstream of the load in the current path; and a processing unit configured to execute processing, wherein the processing unit gives an instruction to switch ON or OFF a first switch that is either one of the upstream switch and the downstream switch, the processing unit determines whether or not current is flowing through the first switch while an instruction to switch OFF the first switch has been given, and in a case of determining that current is flowing through the first switch, the processing unit gives an instruction to switch OFF a second switch that is another one of the upstream switch and the downstream switch.

The power supply control device according to an aspect of the present disclosure may have a configuration in which the current path is a path of current output from a fuse, the processing unit receives a supply of power from a connection node between the fuse and the upstream switch, and the processing unit executes transmission processing for transmitting data to an external device.

The power supply control device according to an aspect of the present disclosure may have a configuration in which the processing unit gives an instruction to switch ON or OFF the upstream switch, the processing unit determines whether or not current is flowing through the upstream switch while an instruction to switch OFF the upstream switch has been given, and in a case of determining that current is flowing through the upstream switch, the processing unit gives an instruction to switch OFF the downstream switch.

The power supply control device according to an aspect of the present disclosure may have a configuration in which the processing unit acquires a voltage value of a downstream end of the upstream switch while the instruction to switch OFF the upstream switch has been given, and in a case where the acquired voltage value is greater than or equal to a voltage threshold value, the processing unit determines that current is flowing through the upstream switch.

The power supply control device according to an aspect of the present disclosure may have a configuration in which the power supply control device includes two of the downstream switches, the two downstream switches are each a semiconductor switch, a parasitic diode is connected across each of the two downstream switches, and an anode of the parasitic diode of one of the downstream switches is connected to an anode of the parasitic diode of another one of the downstream switches.

The power supply control device according to an aspect of the present disclosure may have a configuration in which the power supply control device includes two of the downstream switches, the two downstream switches are each a semiconductor switch, a parasitic diode is connected across each of the two downstream switches, and a cathode of the parasitic diode of one of the downstream switches is connected to a cathode of the parasitic diode of another one of the downstream switches.

The power supply control device according to an aspect of the present disclosure may have a configuration in which a plurality of loads are respectively arranged in current paths of a plurality of currents, the power supply control device includes two of the upstream switches, in each of the current paths, the upstream switch is arranged upstream of the load in the current path, the plurality of currents flow through a common downstream switch, the processing unit gives instructions to switch ON or OFF each of the upstream switches, while having given an instruction to switch OFF one upstream switch among the plurality of upstream switches, the processing unit determines whether or not current is flowing through the one upstream switch for which the switch OFF instruction was given, and in a case of determining that current is flowing through the one upstream switch for which the switch OFF instruction was given, the processing unit gives an instruction to switch OFF the downstream switch.

A power supply control method according to an aspect of the present disclosure is a power supply control method of controlling a supply of power to a load, the power supply control method causing a computer to execute the steps of: giving an instruction to switch ON or OFF a first switch that is either one of an upstream switch arranged upstream of the load in a current path of a flow of current through the load and a downstream switch arranged downstream of the load in the current path; determining whether or not current is flowing through the first switch while an instruction to switch OFF the first switch has been given; and giving an instruction to switch OFF a second switch that is another one of the upstream switch and the downstream switch in a case where a determination was made that current is flowing through the first switch.

In the power supply control device and the power supply control method according to an above aspect, when a short-circuit failure occurs in the first switch, an instruction is given to switch OFF the second switch. The second switch thus switches OFF, and therefore the supply of power to the load stops. A short-circuit failure in the first switch is a phenomenon in which current flows through the first switch even though an instruction was given to switch OFF the first switch.

In the power supply control device according to an above aspect, when a short-circuit failure occurs in the first switch, the second switch switches OFF. After the second switch switches OFF, the current flowing through the fuse is current for supplying power to the processing unit, and the current value of the current flowing through the fuse is small. As a result, the possibility of the fuse blowing is low. As long as the fuse has not blown, power continues to be supplied to the processing unit. Therefore, even if a short-circuit failure occurs in the first switch, the processing unit can continue to execute processing for transmitting data to an external device.

In the power supply control device according to an above aspect, the first switch is the upstream switch, and the second switch is the downstream switch.

In the power supply control device according to an above aspect, current flows from the positive electrode of a DC power supply to the upstream switch, the load, and the downstream switch in this order, and returns to the negative electrode of the DC power supply, for example. If the upstream switch is OFF while the downstream switch is ON, the voltage value at the downstream end of the upstream switch is substantially zero V. If a short-circuit failure occurs in the upstream switch while the downstream switch is ON, the voltage value at one end of the downstream switch is relatively high. The processing unit detects the occurrence of a short-circuit failure in the upstream switch if the voltage value at the downstream end of the upstream switch is greater than or equal to the voltage threshold value while the downstream switch is ON.

In the power supply control device according to an above aspect, the anode of the parasitic diode of one downstream switch is connected to the anode of the other downstream switch. Therefore, even if the positive electrode of the DC power supply is mistakenly connected to the downstream end of the series circuit that includes the two downstream switches, as long as the two downstream switches are OFF, current does not flow through the parasitic diodes of the two downstream switches.

In the power supply control device according to an above aspect, the cathode of the parasitic diode of one downstream switch is connected to the cathode of the other downstream switch. Therefore, even if the positive electrode of the DC power supply is mistakenly connected to the downstream end of the series circuit that includes the two downstream switches, as long as the two downstream switches are OFF, current does not flow through the parasitic diodes of the two downstream switches.

In the power supply control device according to an above aspect, the supply of power to a plurality of loads can be stopped by switching OFF the common downstream switch.

### DETAILS OF EMBODIMENTS OF PRESENT DISCLOSURE

Specific examples of a power supply system according to an embodiment of the present disclosure will be described below with reference to the drawings. Note that the present disclosure is not limited to these examples, but rather is indicated by the scope of the claims, and is intended to include all modifications within the scope and meaning equivalent to the scope of the claims.

### FIRST EMBODIMENT

### Configuration of Power Supply System

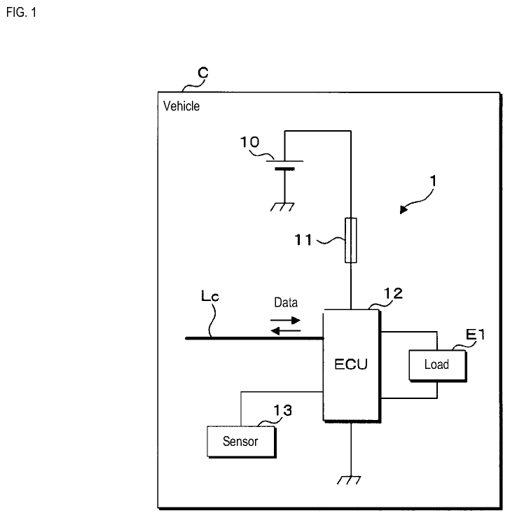

FIG. 1 is a block diagram showing the configuration of a relevant portion of a power supply system 1 in a first embodiment. The power supply system 1 is installed in a vehicle C. The power supply system 1 includes a DC power supply 10, a fuse 11, an ECU 12, a sensor 13, and a load E1. The DC power supply 10 is a battery, for example. The fuse 11 is a mechanical fuse such as a chip fuse, a blade fuse, a thermal fuse, or a fusible link. Also, ECU is an abbreviation for Electronic Control Unit.

The negative electrode of the DC power supply 10 is grounded. This grounding is realized by connection to the body of vehicle C, for example. The positive electrode of the DC power supply 10 is connected to one end of the fuse 11. The other end of the fuse 11 is connected to the ECU 12. The ECU 12 is grounded. The ECU 12 is also connected to the two terminals of the load E1. The ECU 12 is also connected to the sensor 13. The ECU 12 is also connected to a communication line Lc. The communication line Lc is connected to one or more communication devices (not shown) installed in the vehicle C.

Current flows from the positive electrode of the DC power supply 10 to the fuse 11 and the ECU 12 in this order, and returns to the negative electrode of the DC power supply 10. The DC power supply 10 supplies power to the ECU 12. The ECU 12 performs various operations using power supplied from the DC power supply 10. The ECU 12 controls the supply of power to the load E1. The ECU 12 functions as a power supply control device. While power is supplied to the load E1, current flows from the positive electrode of the DC power supply 10 to the fuse 11, the ECU 12, the load E1, and the ECU 12 in this order, and returns to the negative electrode of the DC power supply 10.

The load E1 is an electrical device. The load E1 operates while power is supplied to the load E1. When the supply of power to the load E1 stops, the load E1 stops operating.

The sensor 13 detects a vehicle value regarding the vehicle C. As a first example, the vehicle value is the speed or the acceleration of the vehicle C, the brightness around the vehicle C, or the like. As a second example, the vehicle value is a value that indicates a state regarding the vehicle C. One example of a state regarding the vehicle C is the state of an operation switch operated by a passenger of the vehicle C. The sensor 13 repeatedly outputs sensor data indicating the detected vehicle value to the ECU 12. Note that the sensor 13 may capture an image instead of detecting a vehicle value. In this case, the sensor data is the image data of a captured image.

The ECU 12 receives communication data from one or more communication devices via the communication line Lc. The ECU 12 determines whether or not power is to be supplied to the load E1 based on the received communication data or sensor data received from the sensor 13, for example. The ECU 12 determines whether or not to the supply of power to the load E1 is to be stopped based on the received communication data or sensor data input from the sensor 13, for example.

The ECU 12 transmits the sensor data received from the sensor 13 to a communication device via the communication line Lc. The communication device performs various operations based on the sensor data received from the ECU 12.

When current flows through the fuse 11, the fuse 11 generates heat. The amount of heat generated by the fuse 11 increases as the current value of the current flowing through the fuse 11 increases. If the amount of heat generated by the fuse 11 per unit time is greater than the amount of heat released per unit time, the temperature of the fuse 11 rises. The greater the difference is between the amount of heat generated and the amount of heat released, the faster the temperature of the fuse 11 rises. If the amount of heat generated by the fuse 11 per unit time is smaller than the amount of heat released per unit time, the temperature of the fuse 11 decreases. The larger the difference is between the amount of heat generated and the amount of heat released, the faster the temperature of the fuse 11 decreases. If the temperature of the fuse 11 rises to a temperature above a certain temperature threshold, the fuse 11 blows.

If a current with a large current value flows through the fuse 11, the fuse 11 blows. This prevents the flow of overcurrent from the DC power supply 10.

### Configuration of ECU 12

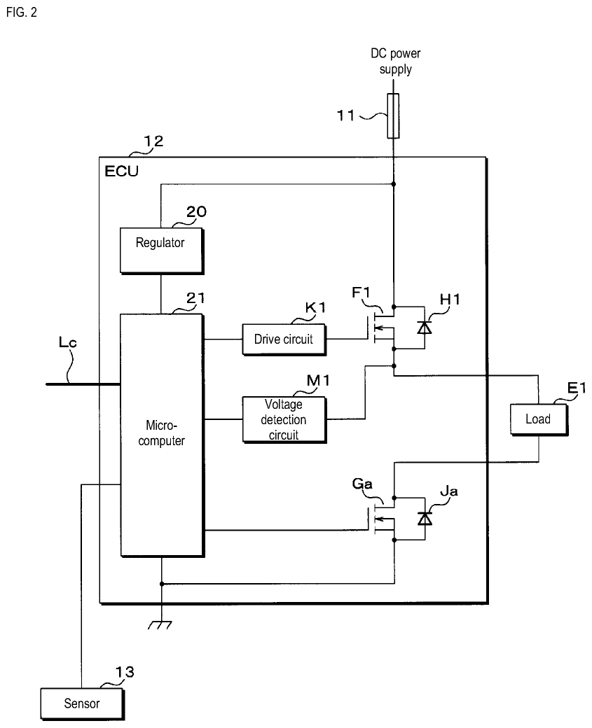

FIG. 2 is a block diagram showing the configuration of a relevant portion of the ECU 12. The ECU 12 includes a regulator 20, a microcomputer 21, an upstream switch F1, a downstream switch Ga, a drive circuit K1, and a voltage detection circuit M1. The term “microcomputer” may be abbreviated as MC. The upstream switch F1 and the downstream switch Ga are each an N-channel MOSFET (Metal Oxide Semiconductor Field Effect Transistor). Therefore, the upstream switch F1 and the downstream switch Ga are each a semiconductor switch.

A parasitic diode H1 is connected between the drain and the source of the upstream switch F1. The cathode and the anode of the parasitic diode H1 are respectively connected to the drain and the source of the upstream switch F1. Also, a parasitic diode Ja is connected between the drain and the source of the downstream switch Ga. The cathode and the anode of the parasitic diode Ja are respectively connected to the drain and the source of the downstream switch Ga.

The downstream end of the fuse 11 is connected to the drain of the upstream switch F1. The source of the upstream switch F1 is connected to the upstream end of the load E1. The downstream end of the load E1 is connected to the drain of the downstream switch Ga. The source of the downstream switch Ga is grounded.

The connection node between the fuse 11 and the upstream switch F1 is also connected to the regulator 20. The regulator 20 is also connected to the microcomputer 21. The gate of the upstream switch F1 is connected to the drive circuit K1. The drive circuit K1 is also connected to the microcomputer 21. The source of the upstream switch F1 is also connected to the voltage detection circuit M1. The voltage detection circuit M1 is also connected to the microcomputer 21. The gate of the downstream switch Ga is connected to the microcomputer 21. The microcomputer 21 is grounded. The microcomputer 21 is also connected to the sensor 13 and the communication line Lc.

For both the upstream switch F1 and the downstream switch Ga, as the voltage value of the gate, whose reference potential is the potential of the source, increases, the resistance value between the drain and the source decreases. The upstream switch F1 and the downstream switch Ga are each ON when the voltage value of the gate, whose reference potential is the potential of the source, is greater than or equal to a certain voltage value. In the ON state, the resistance value between the drain and the source is relatively small. Therefore, current can flow through the drain and the source.

The upstream switch F1 and the downstream switch Ga are each OFF when the voltage value of the gate, whose reference potential is the potential of the source, is less than the certain voltage value. In the OFF state, the resistance value between the drain and the source is relatively large. Therefore, current does not flow through the drain and the source.

When the upstream switch F1 and the downstream switch Ga are ON, current flows from the positive electrode of the DC power supply 10 to the fuse 11, the upstream switch F1, the load E1, and the downstream switch Ga in this order. At this time, power is supplied to the load E1. When at least either the upstream switch F1 or the downstream switch Ga is off, current does not flow through the load E1.

As described above, the current output from the fuse 11 flows to the upstream switch F1, the load E1, and the downstream switch Ga in this order. Therefore, the current path of the current flowing through the upstream switch F1, the load E1, and the downstream switch Ga is the path of the current output from the fuse 11. In this current path, the upstream switch F1 is arranged upstream of the load E1. In this current path, the downstream switch Ga is arranged downstream of the load E1.

The voltage at the connection node between the fuse 11 and the drain of the upstream switch F1 will be described as the node voltage. The reference potential of the node voltage is the ground potential. The regulator 20 steps down the node voltage to a certain target voltage. The reference potential of the target voltage is the ground potential. The regulator 20 applies the stepped-down target voltage to the microcomputer 21. As a result, current flows from the positive electrode of the DC power supply 10 to the fuse 11, the regulator 20, and the microcomputer 21 in this order, and returns to the negative electrode of the DC power supply 10. The DC power supply 10 supplies power to the microcomputer 21 via the fuse 11 and the regulator 20. The microcomputer 21 performs various operations using power supplied from the DC power supply 10.

The microcomputer 21 outputs a high level voltage or a low level voltage to the drive circuit K1. The reference potential of the high level voltage and the low level voltage output by the microcomputer 21 is the ground potential. The microcomputer 21 switches the voltage output to the drive circuit K1 to the high level voltage or the low level voltage. If the voltage received from the microcomputer 21 is switched from the low level voltage to the high level voltage, the drive circuit K1 raises the voltage value of the gate of the upstream switch F1. Hereinafter, the voltage value of the gate will be referred to as the gate voltage value. The reference potential of the gate voltage value is the ground potential.

When the drive circuit K1 raises the gate voltage value of the upstream switch F1, in the upstream switch F1, the voltage value of the gate, whose reference potential is the source potential, rises to a voltage value greater than or equal to a certain voltage value. The upstream switch F1 thus switches ON.

If the voltage received from the microcomputer 21 has switched from a high level voltage to a low level voltage, the drive circuit K1 lowers the gate voltage value of the upstream switch F1. In this case, in the upstream switch F1, the voltage value of the gate, whose reference potential is the potential of the source, decreases to a voltage value below the certain voltage value. The upstream switch F1 thus switches OFF. As described above, the drive circuit K1 switches the upstream switch F1 ON or OFF by adjusting the voltage value of the gate of the upstream switch F1.

The voltage detection circuit M1 detects the voltage value of the source of the upstream switch F1. Hereinafter, the voltage value of the source will be referred to as the source voltage value. The reference potential of the source voltage value is the ground potential. The voltage detection circuit M1 outputs analog voltage value information indicating the detected source voltage value to the microcomputer 21. The voltage value information is a voltage value obtained by dividing the source voltage of the upstream switch F1, for example.

The microcomputer 21 outputs a high level voltage or a low level voltage to the gate of the downstream switch Ga. When the microcomputer 21 outputs a high level voltage to the gate of the downstream switch Ga, in the downstream switch Ga, the voltage value of the gate, whose reference potential is the potential of the source, is greater than or equal to a certain voltage value. As a result, the downstream switch Ga is ON. When the microcomputer 21 outputs a low level voltage to the gate of the downstream switch Ga, in the downstream switch Ga, the voltage of the gate, whose reference potential is the potential of the source, is less than the certain voltage value. As a result, the downstream switch Ga is OFF.

As described above, the microcomputer 21 switches the downstream switch Ga ON or OFF by switching the voltage output to the gate of the downstream switch Ga to a high level voltage or a low level voltage. A circuit for switching the downstream switch Ga ON or OFF is not required.

The microcomputer 21 receives communication data via the communication line Lc. The sensor 13 outputs sensor data to the microcomputer 21. For example, when the ignition switch of the vehicle C is turned on, the microcomputer 21 switches ON the downstream switch Ga. The microcomputer 21 determines whether or not power is to be supplied to the load E1 based on the received communication data or the sensor data received from the sensor 13, for example. In the case of determining that power is to be supplied to the load E1, the microcomputer 21 keeps the downstream switch Ga ON and switches the voltage output to the drive circuit K1 from the low level voltage to the high level voltage. Accordingly, the drive circuit K1 switches ON the upstream switch F1. As a result, power is supplied to the load E1.

The microcomputer 21 determines whether or not the supply of power to the load E1 is to be stopped based on the received communication data or the sensor data received from the sensor 13, for example. In the case of determining that the supply of power to the load E1 is to be stopped, the microcomputer 21 keeps the downstream switch Ga ON and switches the voltage output to the drive circuit K1 from the high level voltage to the low level voltage. Accordingly, the drive circuit K1 switches OFF the upstream switch F1. As a result, the supply of power to the load E1 stops. For example, when the ignition switch of the vehicle C is turned off, the microcomputer 21 switches OFF the downstream switch Ga.

The microcomputer 21 determines whether or not a short-circuit failure has occurred in the upstream switch F1 based on the voltage value information received from the voltage detection circuit M1, that is to say the source voltage value of the upstream switch F1 detected by the voltage detection circuit M1. A short-circuit failure in the upstream switch F1 is a phenomenon in which current flows through the drain and the source of the upstream switch F1 even though the upstream switch F1 was instructed to switch OFF. In the case of determining that a short-circuit failure occurred in the upstream switch F1, the microcomputer 21 switches OFF the downstream switch Ga.

### Configuration of Microcomputer 21

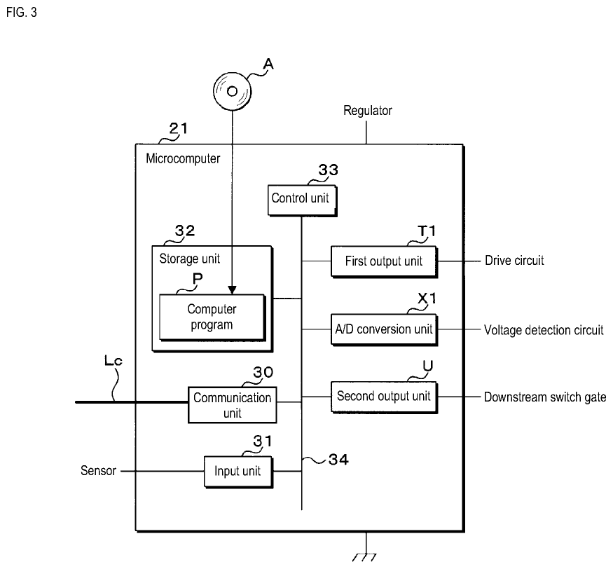

FIG. 3 is a block diagram showing the configuration of a relevant portion of the microcomputer 21. The microcomputer 21 includes a communication unit 30, an input unit 31, a storage unit 32, a control unit 33, a first output unit T1, a second output unit U, and an A/D conversion unit X1. These units are connected to an internal bus 34. The first output unit T1 is also connected to the drive circuit K1. The A/D conversion unit X1 is also connected to the voltage detection circuit M1. The second output unit U is also connected to the gate of the downstream switch Ga. The communication unit 30 is also connected to the communication line Lc. The input unit 31 is also connected to the sensor 13.

As described above, the DC power supply 10 supplies power to the microcomputer 21 via the fuse 11 and the regulator 20. When power is supplied to the microcomputer 21, power is supplied to the communication unit 30, the input unit 31, the storage unit 32, the control unit 33, the first output unit T1, and the second output unit U. Accordingly, power from the connection node between the fuse 11 and the upstream switch F1 is supplied to the A/D conversion unit X1, the communication unit 30, the input unit 31, the storage unit 32, the control unit 33, the first output unit T1, the second output unit U, and the A/D conversion unit X1.

The first output unit T1 outputs a high level voltage or a low level voltage to the drive circuit K1. The voltage that the microcomputer 21 outputs to the drive circuit K1 is the voltage that the first output unit T1 outputs to the drive circuit K1. The control unit 33 instructs the first output unit T1 to switch the upstream switch F1 ON or OFF. If the control unit 33 instructs the first output unit T1 to switch ON the upstream switch F1, the first output unit T1 switches the voltage output to the drive circuit K1 to a high level voltage. If the control unit 33 instructs the first output unit T1 to switch OFF the upstream switch F1, the first output unit T1 switches the voltage output to the drive circuit K1 to a low level voltage.

The voltage detection circuit M1 outputs analog voltage value information to the A/D conversion unit X1. The A/D conversion unit X1 converts the analog voltage value information received from the voltage detection circuit M1 into digital voltage value information. The control unit 33 acquires the digital voltage value information obtained by the conversion performed by the A/D conversion unit X1. As described above, the voltage value information indicates the source voltage value of the upstream switch F1. The acquisition of the voltage value information corresponds to acquiring the source voltage value of the upstream switch F1.

The second output unit U outputs a high level voltage or a low level voltage to the gate of the downstream switch Ga. The voltage that the microcomputer 21 outputs to the gate of the downstream switch Ga is the voltage that the second output unit U outputs to the gate of the downstream switch Ga. The control unit 33 instructs the second output unit U to switch the downstream switch Ga ON or OFF.

When the control unit 33 instructs the second output unit U to switch ON the downstream switch Ga, the second output unit U switches the voltage output to the gate of the downstream switch Ga to a high level voltage. The downstream switch Ga thus switches ON. When the control unit 33 instructs the second output unit U to switch OFF the downstream switch Ga, the second output unit U switches the voltage output to the gate of the downstream switch Ga to a low level voltage. The downstream switch Ga thus switches OFF.

The communication unit 30 receives communication data transmitted by the communication device via the communication line Lc. The communication unit 30 transmits sensor data to the communication device in accordance with an instruction from the control unit 33. The sensor 13 outputs sensor data to the input unit 31.

The storage unit 32 is configured by a volatile memory and a nonvolatile memory, for example. A computer program P is stored in the storage unit 32. The control unit 33 includes a processing element that executes processing. The control unit 33 functions as a processing unit. The processing element is a CPU (Central Processing Unit), and is a computer, for example. By executing the computer program P, the processing element of the control unit 33 executes write processing, transmission processing, downstream switch control processing, power supply control processing, and the like in parallel.

The write processing is processing for writing communication data and sensor data to the storage unit 32. The transmission processing is processing for transmitting communication data to the communication device. The downstream switch control processing is processing for switching the downstream switch Ga ON or OFF. The power supply control processing is processing for controlling the supply of power to the load E1.

Note that the computer program P may be provided to the microcomputer 21 with use of a non-temporary storage medium A that readably stores the computer program P. The storage medium A is a portable memory, for example. If the storage medium A is a portable memory, the processing element of the control unit 33 may read the computer program P from the storage medium A with use of a reading device (not shown). The computer program P that was read is written to the storage unit 32. Alternatively, the computer program P may be provided to the microcomputer 21 by a communication unit (not shown) of the microcomputer 21 communicating with an external device. In this case, the processing element of the control unit 33 acquires the computer program P through the communication unit. The acquired computer program P is written to the storage unit 32.

The control unit 33 may include two or more processing elements. In this case, the processing elements of the control unit 33 may execute the write processing, the transmission processing, the downstream switch control processing, the power supply control processing, and the like in cooperation with each other.

### Write Processing

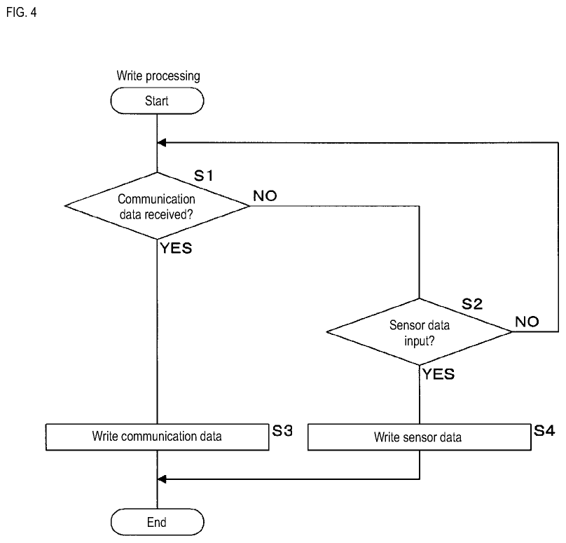

FIG. 4 is a flowchart showing a procedure of write processing. In the write processing, the control unit 33 first determines whether or not the communication unit 30 received communication data via the communication line Lc (step S1). In the case of determining that the communication unit 30 has not received communication data (S1: NO), the control unit 33 determines whether or not sensor data was input to the input unit 31 by the sensor 13 (step S2). In the case of determining that sensor data was not input to the input unit 31 (S2: NO), the control unit 33 executes step S1 again. The control unit 33 waits until the communication unit 30 receives communication data or until sensor data is input to the input unit 31.

In the case of determining that the communication unit 30 received communication data (S1: YES), the control unit 33 writes the communication data received by the communication unit 30 to the storage unit 32 (step S3). In the case of determining that sensor data was input to the input unit 31 (S2: YES), the control unit 33 writes, to the storage unit 32, the sensor data that was input to the input unit 31 (step S4). After executing either step S3 or S4, the control unit 33 ends the write processing. After ending the write processing, the control unit 33 executes the write processing again.

### Transmission Processing

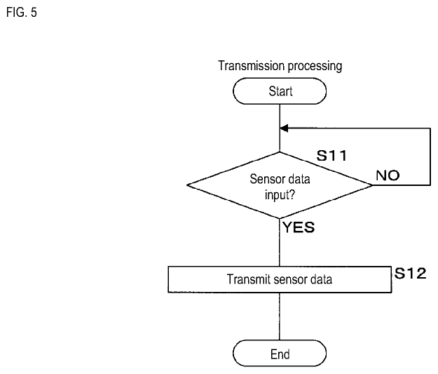

FIG. 5 is a flowchart showing a procedure of transmission processing. In the transmission processing, the control unit 33 determines whether or not sensor data was input to the input unit 31 by the sensor 13 (step S11). In the case of determining that sensor data was not input to the input unit 31 (S11: NO), the control unit 33 executes step S11 again. The control unit 33 waits until sensor data is input to the input unit 31.

In the case of determining that sensor data was input to the input unit 31 (S11: YES), the control unit 33 instructs the communication unit 30 to transmit the sensor data to the communication device via the communication line Lc (step S12). After executing step S12, the control unit 33 ends the transmission processing. After ending the transmission processing, the control unit 33 executes the transmission processing again. The transmission processing is not related to the control of the supply of power to the load E1. Therefore, the transmission processing is different from the processing related to the control of the supply of power to the load E1.

### Downstream Switch Control Processing

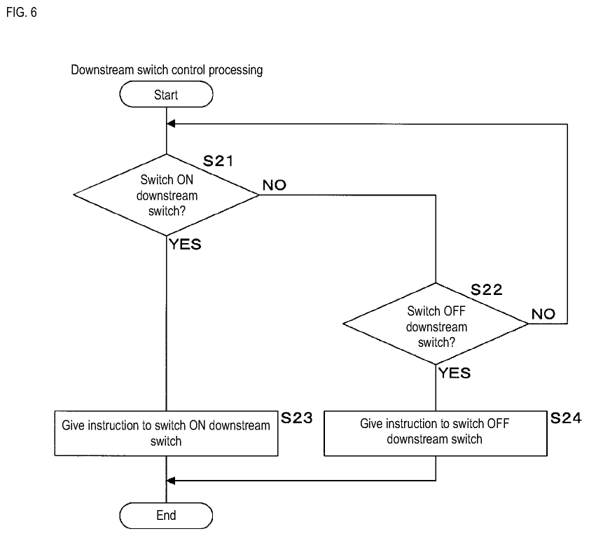

FIG. 6 is a flowchart showing a procedure of downstream switch control processing. In the downstream switch control processing, the control unit 33 determines whether or not to switch ON the downstream switch Ga (step S21). In step S21, if IG ON information indicating that the ignition switch of the vehicle C was turned on is input to an input unit (not shown), for example, the control unit 33 determines to switch ON the downstream switch Ga. If the IG ON information has not been input, the control unit 33 determines not to switch ON the downstream switch Ga.

In the case of determining not to switch ON the downstream switch Ga (S21: NO), the control unit 33 determines whether or not to switch OFF the downstream switch Ga (step S22). In step S22, if IG OFF information indicating that the ignition switch of the vehicle C was turned off is input to an input unit (not shown), for example, is it determined that the downstream switch Ga is to be switched OFF. If the IG OFF information has not been input, the control unit 33 determines not to switch OFF the downstream switch Ga. In the case of determining that the downstream switch Ga is not to be switched OFF (S22: NO), the control unit 33 executes step S21 again. The control unit 33 waits until arrival of a timing for switching the downstream switch Ga ON or OFF.

In the case of determining that the downstream switch Ga is to be switched ON (S21: YES), the control unit 33 instructs the second output unit U to switch ON the downstream switch Ga (step S23). Accordingly, the second output unit U switches the voltage output to the gate of the downstream switch Ga to a high level voltage. As a result, the downstream switch Ga switches ON.

In the case of determining that the downstream switch Ga is to be switched OFF (S22: YES), the control unit 33 instructs the second output unit U to switch OFF the downstream switch Ga (step S24). Accordingly, the second output unit U switches the voltage output to the gate of the downstream switch Ga to a low level voltage. As a result, the downstream switch Ga switches OFF. After executing either step S23 or S24, the control unit 33 ends the downstream switch control processing. After ending the downstream switch control processing, the control unit 33 executes the downstream switch control processing again.

### Power Supply Control Processing

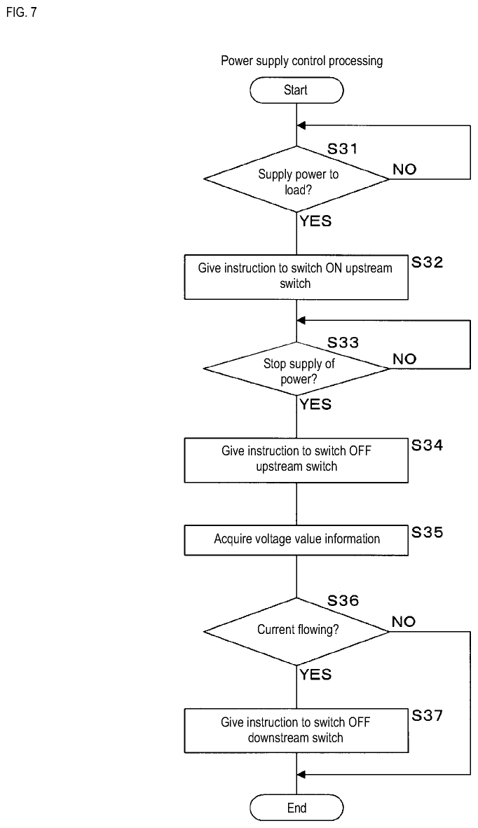

FIG. 7 is a flowchart showing a procedure of power supply control processing. The control unit 33 executes the power supply control processing when the downstream switch Ga is ON. In the power supply control processing, the control unit 33 first determines whether or not power is to be supplied to the load E based on, for example, the most recent communication data or the most recent sensor data stored in the storage unit 32 (step S31). In the case of determining that power is not to be supplied to the load E1 (S31: NO), the control unit 33 executes step S31 again. The control unit 33 waits until the arrival of a timing for supplying power to the load E1.

In the case of determining that power is to be supplied to the load E1 (S31: YES), the control unit 33 instructs the first output unit T1 to switch ON the upstream switch F1 (step S32). Accordingly, the first output unit T1 switches the voltage output to the drive circuit K1 to a high level voltage. The drive circuit K1 switches ON the upstream switch F1. The upstream switch F1 functions as a first switch.

After executing step S32, the control unit 33 determines whether or not the supply of power to the load E1 is to be stopped based on, for example, the most recent communication data or the most recent sensor data stored in the storage unit 32 (step S33). In the case of determining that the supply of power to the load E1 is not to be stopped (S33: NO), the control unit 33 executes step S33 again. The control unit 33 waits until the arrival of a timing for stopping the supply of power to the load E1.

In the case of determining that the supply of power to the load E1 is to be stopped (S33: YES), the control unit 33 instructs the first output unit T1 to switch OFF the upstream switch F1 (step S34). Accordingly, the first output unit T1 switches the voltage output to the drive circuit K1 to a low level voltage. The drive circuit K1 switches OFF the upstream switch F1. If the first output unit T1, the drive circuit K1, or the upstream switch F1 has not operated correctly, the upstream switch F1 does not switch OFF.

After executing step S34, the control unit 33 acquires voltage value information from the A/D conversion unit X1 while giving an instruction to switch OFF the upstream switch F1 (step S35). The source voltage value of the upstream switch F1 indicated by the voltage value information acquired by the control unit 33 substantially matches the source voltage value of the upstream switch F1 at the time of acquisition. As described above, the acquisition of the voltage value information corresponds to the acquisition of the source voltage value of the upstream switch F1.

Next, the control unit 33 determines whether or not current is flowing through the upstream switch F1 based on the source voltage value of the upstream switch F1 indicated by the voltage value information acquired in step S35 (step S36). The control unit 33 executes step S36 while giving the instruction to switch OFF the upstream switch F1. As described above, a short-circuit failure is a phenomenon in which current flows through the upstream switch F1 even though the upstream switch F1 was instructed to switch OFF. In step S36, the control unit 33 determines whether or not a short-circuit failure has occurred.

A certain positive value near zero V will be described as the voltage threshold value. If current is not flowing through the upstream switch F1, current is not flowing through the load E1. Therefore, the source voltage value of the upstream switch F1 is substantially zero V, which is lower than the voltage threshold value. If current is flowing through upstream switch F1, current is flowing through the load El. Therefore, the source voltage value of the upstream switch F1 is relatively high, and is greater than or equal to the voltage threshold value. When the upstream switch F1 and the downstream switch Ga are ON, the source voltage value of the upstream switch F1 substantially matches the voltage value across the DC power supply 10.

In step S36, if the source voltage value of the upstream switch F1 indicated by the voltage value information acquired in step S35 is lower than the voltage threshold value, the control unit 33 determines that current is not flowing through the upstream switch F1. In step S36, if the source voltage value of the upstream switch F1 indicated by the voltage value information acquired in step S35 is greater than or equal to the voltage threshold value, the control unit 33 determines that current is flowing through the upstream switch F1. As described above, if the source voltage value of the upstream switch F1 is greater than or equal to the voltage threshold value while the downstream switch Ga is ON and the upstream switch F1 has been instructed to switch OFF, the control unit 33 detects the occurrence of a short-circuit failure in the upstream switch F1.

In the case of determining that current is not flowing through the upstream switch F1 (S36: NO), the control unit 33 ends the power supply control processing. If the downstream switch Ga is ON when the power supply control processing is finished, the control unit 33 executes the power supply control processing again.

In the case of determining that current is flowing through the upstream switch F1 (S36: YES), the control unit 33 determines that a short-circuit failure has occurred, and instructs the second output unit U to switch OFF the downstream switch Ga (step S37). Accordingly, the second output unit U switches the voltage output to the gate of the downstream switch Ga to a low level voltage. The downstream switch Ga thus switches OFF. As a result, the supply of power to the load E1 stops. After executing step S37, the control unit 33 ends the power supply control processing. In this case, the power supply control processing ends while the downstream switch Ga OFF, and thus the control unit 33 does not execute the power supply control processing again. The downstream switch Ga functions as a second switch.

### Effects of ECU 12

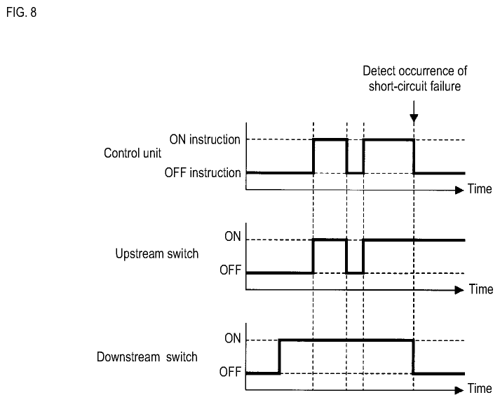

FIG. 8 is a timing chart for describing effects of the ECU 12. FIG. 8 shows instructions given by the control unit 33 and transitions of the state of the upstream switch F1 and the state of the downstream switch Ga. Time in these transitions is shown on the horizontal axis. An ON instruction is an instruction to switch ON the upstream switch F1. An OFF instruction is an instruction to switch OFF the upstream switch F1. In FIG. 8, a switch from the OFF instruction to the ON instruction signifies execution of the ON instruction. Also, a switch from the ON instruction to the OFF instruction signifies execution of the OFF instruction.

For example, when the ignition switch of the vehicle C is turned on, the control unit 33 instructs the second output unit U to switch ON the downstream switch Ga. Accordingly, as shown in FIG. 8, the downstream switch Ga switches ON. The control unit 33 executes the power supply control processing while the downstream switch Ga is ON. If the first output unit T1, the drive circuit K1, and the upstream switch F1 are operating normally, the upstream switch F1 switches ON when the control unit 33 issues the ON instruction. In a similar case, when the control unit 33 issues the OFF instruction, the upstream switch F1 switches OFF.

When the upstream switch F1 switches ON, power is supplied to the load E1. The load E1 thus operates. When the upstream switch F1 switches OFF, the supply of power to the load E1 is stopped. The load E1 thus stops operating.

If the upstream switch F1 remains ON even though the control unit 33 issued the OFF instruction, the source voltage value of the upstream switch F1 substantially matches the voltage value across the DC power supply 10. Therefore, the source voltage value of the upstream switch F1 is greater than or equal to the voltage threshold value. The control unit 33 detects the occurrence of a short-circuit failure in the upstream switch F1. Upon detecting the occurrence of a short-circuit failure in the upstream switch F1, the control unit 33 instructs the second output unit U to switch OFF the downstream switch Ga. The downstream switch Ga thus switches OFF. As a result, the supply of power to the load E1 stops.

Accordingly, if a short-circuit failure occurs in the upstream switch F1, the supply of power to the load E1 is stopped. If a short-circuit failure occurs in the upstream switch F1, the downstream switch Ga switches OFF. After the downstream switch Ga switches OFF, the current flowing through the fuse 11 is current for supplying power to the microcomputer 21, and the current value of the current flowing through the fuse 11 is small. As a result, the likelihood that the fuse 11 will blow is low. As long as the fuse 11 has not blown, the DC power supply 10 continues to supply power to the microcomputer 21. Therefore, even if a short-circuit failure occurs in the upstream switch F1, the control unit 33 can continue to execute the write processing, the transmission processing, and the like.

With a configuration in which the downstream switch Ga is not provided, if a short-circuit failure occurs in the upstream switch F1, the DC power supply 10 continues to supply power to the load E1. If the DC power supply 10 continues to supply power to the load E1 while the generator (not shown) that charges the DC power supply 10 is stopped, the amount of power stored in the DC power supply 10 decreases. If the amount of power supplied to the load E1 is large, there is a high likelihood that the battery will run out. However, with the ECU 12, when a short-circuit failure occurs in the upstream switch F1, the downstream switch Ga switches OFF. Therefore, after a short-circuit failure occurs in the upstream switch F1, the DC power supply 10 does not continue to supply power to the load E1.

### SECOND EMBODIMENT

In the first embodiment, the ECU 12 includes only one downstream switch. However, the ECU 12 may include two downstream switches.

The following describes aspects of the second embodiment that are different from the first embodiment. Configurations other than those described below are the same as in the first embodiment, and therefore constituent elements that are the same as in the first embodiment are denoted by the same reference numerals as in the first embodiment and will not be described.

### Configuration of ECU 12

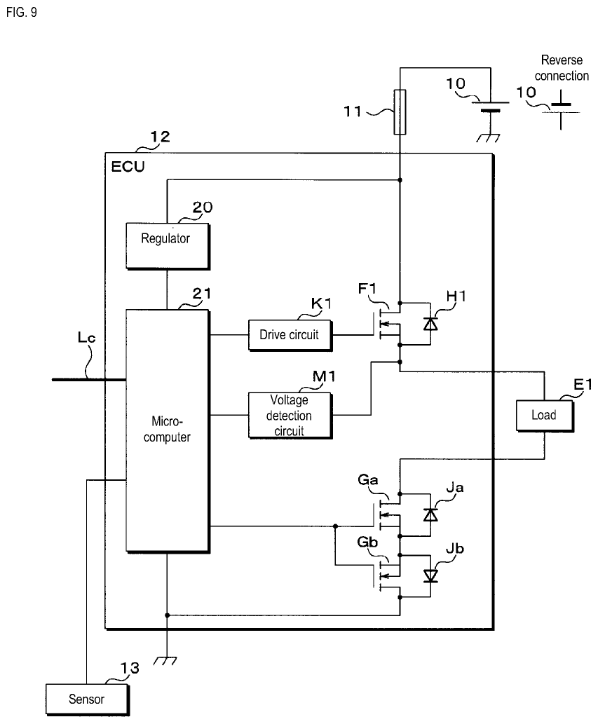

FIG. 9 is a block diagram showing a relevant portion of the ECU 12 according to the second embodiment. The ECU 12 of the second embodiment includes constituent elements similar to those of the ECU 12 of the first embodiment. The ECU 12 of the second embodiment further includes a downstream switch Gb. Similarly to the downstream switch Ga, the downstream switch Gb is an N-channel MOSFET. Therefore, the downstream switches Ga and Gb are each a semiconductor switch.

A parasitic diode Jb is connected between the drain and the source of the downstream switch Gb. The cathode and the anode of the parasitic diode Jb are respectively connected to the drain and the anode of the downstream switch Gb.

In the second embodiment, the source of the downstream switch Ga is not grounded. The source of the downstream switch Ga is connected to the source of the downstream switch Gb. The drain of the downstream switch Gb is grounded. Therefore, the anode of the parasitic diode Ja of the downstream switch Ga is connected to the anode of the parasitic diode Jb of the downstream switch Gb.

As described in the description of the first embodiment, the microcomputer 21 includes the second output unit U (see FIG. 3). The output terminal of the second output unit U that outputs a high level voltage or a low level voltage is connected to the gates of the two downstream switches Ga and Gb.

In the downstream switch Gb, as the voltage value of the gate, whose reference potential is the potential of the source, increases, the resistance value between the drain and the source decreases. The downstream switch Gb is ON when the voltage value of the gate, whose reference potential is the potential of the source, is greater than or equal to a certain voltage value. When the downstream switch Gb is ON, the resistance value between the drain and the source is relatively small. Current can thus flow through the drain and the source of the downstream switch Gb.

The downstream switch Gb is OFF when the voltage value of the gate, whose reference potential is the potential of the source, is less than the certain voltage value. When the downstream switch Gb is OFF, the resistance value between the drain and the source of the downstream switch Gb is relatively large. Therefore, current does not flow through the drain and the source of the downstream switch Gb.

Hereinafter, the term “normal connection state” refers to the connection state of the DC power supply 10 in the case where the positive electrode of the DC power supply 10 is connected to one end of the fuse 11, and the negative electrode of the DC power supply 10 is grounded. Also, the term “reverse connection state” refers to the connection state of the DC power supply 10 in the case where the positive electrode of the DC power supply 10 is grounded, and the negative electrode of the DC power supply 10 is connected to one end of the fuse 11.

When the connection state of the DC power supply 10 is the normal connection state, the second output unit U of the microcomputer 21 outputs a high level voltage or a low level voltage to the gates of the two downstream switches Ga and Gb. The voltages output to the gates of the two downstream switches Ga and Gb are the same. When the second output unit U outputs a high level voltage to the gates of the downstream switches Ga and Gb, in each of the downstream switches Ga and Gb, the voltage value of the gate, whose reference potential is the potential of the source, is greater than or equal to a certain voltage value. As a result, the two downstream switches Ga and Gb are ON.

When the second output unit U outputs a low level voltage to the gates of the two downstream switches Ga and Gb, in each of the downstream switches Ga and Gb, the voltage of the gate, whose reference potential is the source potential, is less than the certain voltage value. As a result, the two downstream switches Ga and Gb are OFF. A circuit for switching the downstream switches Ga and Gb ON or OFF is not required.

As described in the description of the first embodiment, the microcomputer 21 includes the communication unit 30, the input unit 31, the storage unit 32, the control unit 33, the first output unit T1, the second output unit U, and the A/D conversion unit X1 (see FIG. 3). When the connection state of the DC power supply 10 is the normal connection state, power is supplied to the microcomputer 21, and the communication unit 30, the input unit 31, the storage unit 32, the control unit 33, the first output unit T1, the second output unit U and the A/D conversion unit X1 operate.

When the connection state of the DC power supply 10 is the normal connection state, the control unit 33 instructs the second output unit U to switch the two downstream switches Ga and Gb ON or OFF. When the control unit 33 instructs the second output unit U to switch ON the two downstream switches Ga and Gb, the second output unit U switches the voltage output to the gates of the two downstream switches Ga and Gb to a high level voltage. Accordingly, the two downstream switches Ga and Gb switch ON. When the control unit 33 instructs the second output unit U to switch OFF the two downstream switches Ga and Gb, the second output unit U switches the voltage output to the gates of the two downstream switches Ga and Gb to a low level voltage. Accordingly, the two downstream switches Ga and Gb switch OFF.

When the connection state of the DC power supply 10 is the normal connection state and the upstream switch F1 and the two downstream switches Ga and Gb are ON, current flows from the positive electrode of the DC power supply 10 to the fuse 11, the upstream switch F1, the load E1, and the downstream switches Ga and Gb in this order. Therefore, in the current path of the current output from the fuse 11, the two downstream switches Ga and Gb are arranged downstream of the load E1.

When the connection state of the DC power supply 10 is the normal connection state, if the upstream switch F1 is OFF, current does not flow through the load E1, regardless of the state of the two downstream switches Ga and Gb. When the connection state of the DC power supply 10 is the normal connection state, if the two downstream switches Ga and Gb are OFF, current does not flow through the load E1, regardless of the state of the upstream switch F1.

### Configuration of Microcomputer 21

When the connection state of the DC power supply 10 is the normal connection state, the control unit 33 of the microcomputer 21 executes the write processing, the transmission processing, the downstream switch control processing, the power supply control processing, and the like, similarly to the first embodiment.

### Downstream Switch Control Processing

In step S21 of the downstream switch control processing in the second embodiment, the control unit 33 determines whether or not to switch ON the two downstream switches Ga and Gb. Similarly to the first embodiment, the control unit 33 determines whether or not to switch ON the two downstream switches Ga and Gb based on whether or not IG ON information was input to an input unit (not shown), for example.

In step S22 of the downstream switch control processing in the second embodiment, the control unit 33 determines whether or not to switch OFF the two downstream switches Ga and Gb. Similarly to the first embodiment, the control unit 33 determines whether or not to switch OFF the two downstream switches Ga and Gb based on whether or not IG OFF information was input to an input unit (not shown), for example.

In the case where the control unit 33 determines that the two downstream switches Ga and Gb are to be switched ON (S21: YES), in step S23, the control unit 33 instructs the second output unit U to switch ON the two downstream switches Ga and Gb. Accordingly, the two downstream switches Ga and Gb switch ON. In the case where the control unit 33 determines that the two downstream switches Ga and Gb are to be switched OFF (S22: YES), in step S24, the control unit 33 instructs the second output unit U to switch OFF the two downstream switches Ga and Gb. Accordingly, the two downstream switches Ga and Gb switch OFF.

### Power Supply Control Processing

In the second embodiment, the control unit 33 executes the power supply control processing when the two downstream switches Ga and Gb are ON. In step S36, when the upstream switch F1 and the two downstream switches Ga and Gb are ON, the source voltage value of the upstream switch F1 substantially matches the voltage value across the DC power supply 10. If the source voltage value of the upstream switch F1 is greater than or equal to the voltage threshold value while the two downstream switches Ga and Gb are ON and the upstream switch F1 has been instructed to switch OFF, the control unit 33 detects the occurrence of a short-circuit failure in the upstream switch F1.

### Operation of ECU 12 When DC Power Supply 10 is in Reverse Connection State

When the connection state of the DC power supply 10 is the reverse connection state, the regulator 20 does not operate, that is to say has stopped operating. Therefore, power is not supplied to the microcomputer 21, and the microcomputer 21 stops operating. While the microcomputer 21 has stopped operating, the drive circuit K1 keeps the gate voltage value of the upstream switch F1 at zero V. As described in the description of the first embodiment, the reference potential of the gate voltage value is the ground potential.

When the connection state of the DC power supply 10 is the reverse connection state, if the gate voltage value of the upstream switch F1 is zero V, in the upstream switch F1, the voltage value of the gate, whose reference potential is the source potential, is less than a certain voltage value. Therefore, the upstream switch F1 is OFF.

While the microcomputer 21 has stopped operating, the microcomputer 21 keeps the voltage value of the gates of the two downstream switches Ga and Gb at zero V. When the connection state of the DC power supply 10 is the reverse connection state, if the gate voltage value of the two downstream switches Ga and Gb is zero V, in each of the downstream switches Ga and Gb, the voltage value of the gate, whose reference potential is the source potential, is less than the certain voltage value. Therefore, the two downstream switches Ga and Gb are OFF.

As described above, the anode of the parasitic diode Ja of the downstream switch Ga is connected to the anode of the parasitic diode Jb of the downstream switch Gb. Therefore, even if the connection state of the DC power supply 10 is the reverse connection state, as long as the two downstream switches Ga and Gb are OFF, current does not flow through the parasitic diodes Ja and Jb.

The ECU 12 of the second embodiment has effects similar to those of the ECU 12 of the first embodiment.

### THIRD EMBODIMENT

In the second embodiment, the anode of the parasitic diode Ja of the downstream switch Ga is connected to the anode of the parasitic diode Jb of the downstream switch Gb. Accordingly, current is prevented from flowing through the parasitic diodes Ja and Jb. However, the configuration for preventing current from flowing through the parasitic diodes Ja and Jb is not limited to a configuration in which the anode of the parasitic diode Ja is connected to the anode of the parasitic diode Jb.

The following describes aspects of a third embodiment that are different from the second embodiment. Configurations other than those described below are the same as in the second embodiment, and therefore constituent elements that are the same as in the second embodiment are denoted by the same reference numerals as in the second embodiment and will not be described.

### Configuration of ECU 12

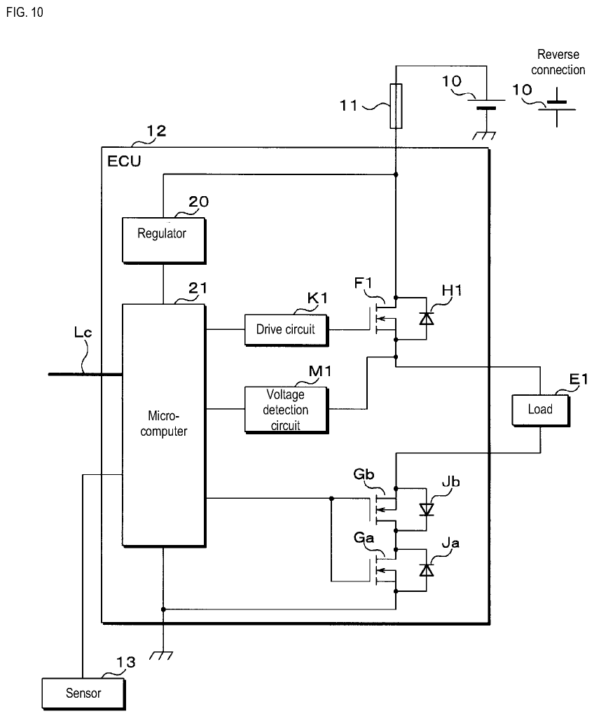

FIG. 10 is a block diagram showing the configuration of a relevant portion of the ECU 12 according to the third embodiment. In the third embodiment, one downstream end of the load E1 is connected to the source of the downstream switch Gb. The drain of the downstream switch Gb is connected to the drain of the downstream switch Ga. The cathode of the downstream switch Ga is thus connected to the cathode of the downstream switch Gb. The source of the downstream switch Ga is grounded.

In the second output unit U of the microcomputer 21, the output terminal that outputs a high level voltage or a low level voltage is connected to the gates of the two downstream switches Ga and Gb, similarly to the second embodiment.

When the connection state of the DC power supply 10 is the normal connection state, the second output unit U of the microcomputer 21 outputs a high level voltage or a low level voltage to the gates of the two downstream switches Ga and Gb, similarly to the second embodiment. The voltages output to the gates of the two downstream switches Ga and Gb are the same. When the second output unit U outputs a high level voltage to the gates of the downstream switches Ga and Gb, in both of the downstream switches Ga and Gb, the voltage value of the gate, whose reference potential is the potential of the source, is greater than or equal to a certain voltage value. As a result, the two downstream switches Ga and Gb are ON.

When the second output unit U outputs a low level voltage to the gates of the two downstream switches Ga and Gb, in each of the downstream switches Ga and Gb, the voltage of the gate, whose reference potential is the source potential, is less than the certain voltage value. As a result, the two downstream switches Ga and Gb are OFF.

When the connection state of the DC power supply 10 is the normal connection state and the upstream switch F1 and the two downstream switches Ga and Gb are ON, current flows from the positive electrode of the DC power supply 10 to the fuse 11, the upstream switch F1, the load E1, and the downstream switches Ga and Gb in this order. Therefore, in the current path of the current output from the fuse 11, the two downstream switches Ga and Gb are arranged downstream of the load E1.

When the connection state of the DC power supply 10 is the normal connection state, if the upstream switch F1 is OFF, current does not flow through the load E1, regardless of the state of the two downstream switches Ga and Gb. When the connection state of the DC power supply 10 is the normal connection state, if the two downstream switches Ga and Gb are OFF, current does not flow through the load E1, regardless of the state of the upstream switch F1.

### Operation of ECU 12 When DC Power Supply 10 is in Reverse Connection State

While the microcomputer 21 has stopped operating, the microcomputer 21 keeps the voltage value of the gates of the two downstream switches Ga and Gb at zero V. When the connection state of the DC power supply 10 is the reverse connection state, if the gate voltage value of the two downstream switches Ga and Gb is zero V, in each of the downstream switches Ga and Gb, the voltage value of the gate, whose reference potential is the source potential, is less than a certain voltage value. Therefore, the two downstream switches Ga and Gb are OFF.

As described above, the cathode of the parasitic diode Ja of the downstream switch Ga is connected to the cathode of the parasitic diode Jb of the downstream switch Gb. Therefore, even if the connection state of the DC power supply 10 is the reverse connection state, as long as the two downstream switches Ga and Gb are OFF, current does not flow through the parasitic diodes Ja and Jb.

The ECU 12 of the third embodiment has effects similar to those of the ECU 12 of the second embodiment.

### FOURTH EMBODIMENT

In the first embodiment, the ECU 12 controls the supply of power to one load E1. However, the ECU 12 may control the supply of power to a plurality of loads.

The following describes aspects of the fourth embodiment that are different from the first embodiment. Configurations other than those described below are the same as in the first embodiment, and therefore constituent elements that are the same as in the first embodiment are denoted by the same reference numerals as in the first embodiment and will not be described.

### Configuration of Power Supply System 1

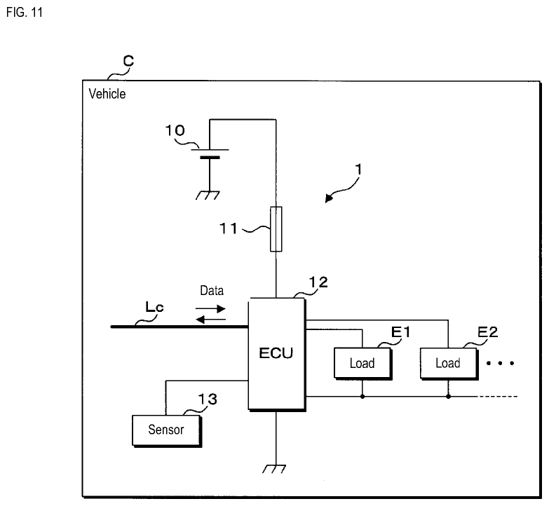

FIG. 11 is a block diagram showing the configuration of a relevant portion of the power supply system 1 according to the fourth embodiment. The power supply system 1 in the fourth embodiment includes constituent elements similar to those of the power supply system 1 according to the first embodiment. The power supply system 1 in the fourth embodiment further includes n-1 loads E2, E3, . . . , En. Here, n is an integer of 2 or more. Accordingly, the power supply system 1 in the fourth embodiment includes n loads E1, E2, . . . , En. Hereinafter, i represents an integer of 2 or more and n or less. The integer i may be any integer in the range of 2 to n.

Each of the loads E1, E2, . . . , En has one end that is separately connected to the ECU 12. The other ends of the loads E1, E2, . . . , En, are connected to the same end of the ECU 12. The ECU 12 controls not only the supply of power to the load E1 but also the supply of power to the load Ei. The supply of power to each of the n loads E1, E2, . . . , En is independently controlled by the ECU 12. While power is supplied to the load Ei, current flows from the positive electrode of the DC power supply 10 to the fuse 11, the ECU 12, the load Ei, and the ECU 12 in this order, and returns to the negative electrode of the DC power supply 10.

Similarly to the load E1, the load Ei is an electrical device. The load Ei operates while power is supplied to the load Ei. When the supply of power to the load Ei stops, the load Ei stops operating. The ECU 12 not only determines whether or not power is to be supplied to the load E1, but also determines whether or not power is to be supplied to the load Ei.

### Configuration of ECU 12

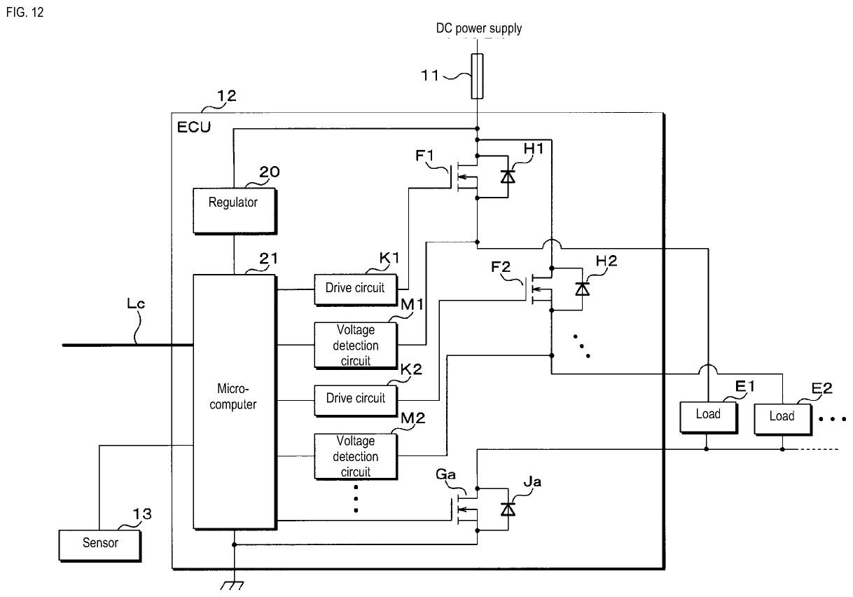

FIG. 12 is a block diagram showing the configuration of a relevant portion of the ECU 12. The ECU 12 of the fourth embodiment includes constituent elements similar to those of the ECU 12 of the first embodiment. The ECU 12 of the fourth embodiment further includes n-1 upstream switches F2, F3, . . . , Fn, n-1 drive circuits K2, K3, . . . , Kn, and n-1 voltage detection circuits M2, M3, . . . , Mn. Therefore, the ECU 12 of the fourth embodiment includes n upstream switches F1, F2, . . . , Fn, n drive circuits K1, K2, . . . , Kn, and n voltage detection circuits M1, M2, . . . , Mn. The upstream switch Fi is an N-channel MOSFET, similarly to the upstream switch F1. Therefore, the upstream switch Fi is a semiconductor switch.

A parasitic diode Hi is connected between the drain and the source of the upstream switch Fi. The cathode and the anode of the parasitic diode Hi are respectively connected to the drain and the source of the upstream switch Fi.

The drain of the upstream switch Fi is connected to the downstream end of the fuse 11. The source of the upstream switch Fi is connected to the upstream end of the load Ei. The downstream end of the load Ei is connected to the drain of the downstream switch Ga. The source of the downstream switch Ga is grounded. The gate of the upstream switch Fi is connected to the drive circuit Ki. The drive circuit Ki is also connected to the microcomputer 21. The source of the upstream switch Fi is also connected to the voltage detection circuit Mi. The voltage detection circuit Mi is also connected to the microcomputer 21.

In the upstream switch Fi, as the voltage value of the gate, whose reference potential is the source potential, increases, the resistance value between the drain and the source decreases. In the upstream switch F1 and the downstream switch Ga, when the voltage value of the gate, whose reference potential is the potential of the source, is greater than or equal to a certain voltage value, the upstream switch Fi is ON. When the upstream switch Fi is ON, the resistance value between the drain and the source of the upstream switch Fi is relatively small. Current can thus flow through the drain and the source of the upstream switch Fi.

For each upstream switch Fi, when the voltage value of the gate, whose reference potential is the potential of the source, is less than the certain voltage value, the upstream switch Fi is OFF. When the upstream switch Fi is OFF, the resistance value between the drain and the source of the upstream switch Fi is relatively large. Therefore, current does not flow through the drain and the source of the upstream switch Fi. When the upstream switch Fi and the downstream switch Ga are ON, current flows from the positive electrode of the DC power supply 10 to the fuse 11, the upstream switch Fi, the load El, and the downstream switch Ga in this order. Power is thus supplied to the load Ei. When at least either the upstream switch Fi or the downstream switch Ga is OFF, current does not flow through the load Ei. Therefore, when the downstream switch Ga is OFF, power is not supplied to the n loads E1, E2, . . . , En.

When the upstream switches F1, F2, . . . , Fn and the downstream switch Ga are ON, the current output from the fuse 11 is divided into n currents. Similarly to the first embodiment, one current flows through the upstream switch F1, the load E1, and the downstream switch Ga in this order. The remaining n-1 currents each flow through the upstream switch Fi, the load Ei, and the downstream switch Ga in this order. Therefore, one of the n loads E1, E2, . . . , En is arranged in the current path of each of the n currents output from the fuse 11. The load arranged in each current path is different from the loads arranged in the other current paths.

In the current path of the current flowing through the load E1, the upstream switch F1 is arranged upstream of the load E1. In this current path, the downstream switch Ga is arranged downstream of the load E1. Similarly, in the current path of the current flowing through the load Ei, the upstream switch Fi is arranged upstream of the load Ei. In this current path, the downstream switch Ga is arranged downstream of the load Ei. Therefore, the n currents flow through the same downstream switch Ga.

The microcomputer 21 outputs a high level voltage or a low level voltage to the drive circuit Ki. The microcomputer 21 switches the voltage output to the drive circuit Ki to a high level voltage or a low level voltage. Similarly to the drive circuit K1, the drive circuit Ki adjusts the gate voltage value of the upstream switch Fi according to the voltage received from the microcomputer 21. The reference potential of the gate voltage value is the ground potential. Similarly to the drive circuit K1, the drive circuit Ki switches the upstream switch Fi ON or OFF in accordance with the voltage received from the microcomputer 21.

Similarly to the voltage detection circuit M1, the voltage detection circuit Mi detects the source voltage value of the upstream switch Fi. The reference potential of the source voltage value is the ground potential. The voltage detection circuit Mi outputs analog voltage value information indicating the detected source voltage value to the microcomputer 21.

The microcomputer 21 determines whether or not power is to be supplied to the load Ei based on received communication data or sensor data received from the sensor 13, for example. In the case of determining that power is to be supplied to the load Ei, the microcomputer 21 keeps the downstream switch Ga ON and switches the voltage output to the drive circuit Ki from the low level voltage to the high level voltage. Accordingly, the drive circuit Ki switches ON the upstream switch Fi. As a result, power is supplied to the load Ei.

The microcomputer 21 determines whether or not the supply of power to the load Ei is to be stopped based on the received communication data or the sensor data received from the sensor 13, for example. In the case of determining that the supply of power to the load Ei is to be stopped, the microcomputer 21 keeps the downstream switch Ga ON and switches the voltage output to the drive circuit Ki from the high level voltage to the low level voltage. Accordingly, the drive circuit Ki switches OFF the upstream switch F1. As a result, the supply of power to the load Ei stops. For example, when the ignition switch of the vehicle C is turned off, the microcomputer 21 switches OFF the downstream switch Ga.

The microcomputer 21 determines whether or not a short-circuit failure has occurred in the upstream switch Fi based on the voltage value information received from the voltage detection circuit Mi, that is to say the source voltage value of the upstream switch Fi detected by the voltage detection circuit Mi. A short-circuit failure of the upstream switch Fi is a phenomenon in which current flows through the drain and the source of the upstream switch Fi even though the upstream switch Fi was instructed to switch OFF. In the case of determining that a short-circuit failure occurred in the upstream switch Fi, the microcomputer 21 switches OFF the downstream switch Ga.

### Configuration of Microcomputer 21

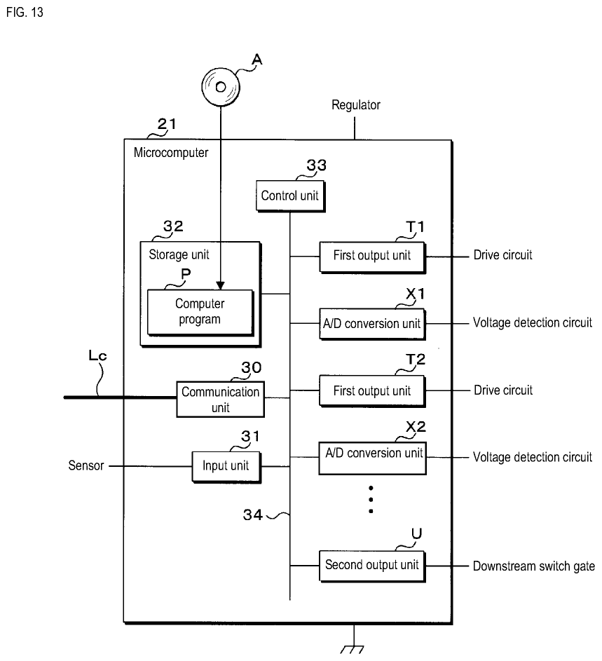

FIG. 13 is a block diagram showing the configuration of a relevant portion of the microcomputer 21. The microcomputer 21 in the fourth embodiment includes constituent elements similar to those of the ECU 12 of the first embodiment. The ECU 12 of the fourth embodiment further includes n-1 first output units T1, T2, . . . , Tn and n-1 A/D conversion units X2, X3, . . . , Xn. The first output unit Ti is also connected to the drive circuit Ki. The A/D conversion unit Xi is also connected to the voltage detection circuit Mi.

When power is supplied to the microcomputer 21, power is supplied to the first output unit Ti and the A/D conversion unit Xi. Power is supplied to the first output unit Ti and the A/D conversion unit Xi from a connection node between the fuse 11 and the upstream switch Fi.

The first output unit Ti outputs a high level voltage or a low level voltage to the drive circuit Ki. The voltage that the microcomputer 21 outputs to the drive circuit Ki is the voltage that the first output unit Ti outputs to the drive circuit Ki. The control unit 33 instructs the first output unit Ti to switch the upstream switch Fi ON or OFF. When the control unit 33 instructs the first output unit Ti to switch ON the upstream switch Fi, the first output unit Ti switches the voltage output to the gate of the drive circuit Ki to a high level voltage. When the control unit 33 instructs the first output unit Ti to switch OFF the upstream switch Fi, the first output unit Ti switches the voltage output to the drive circuit Ki to a low level voltage.

The voltage detection circuit Mi outputs analog voltage value information to the A/D conversion unit Xi. The A/D conversion unit Xi converts the analog voltage value information received from the voltage detection circuit Mi into digital voltage value information. The control unit 33 acquires the digital voltage value information obtained by the A/D conversion unit Xi. As described above, the voltage value information indicates the source voltage value of the upstream switch Fi. The acquisition of the voltage value information obtained by the A/D conversion unit Xi corresponds to the acquisition of the source voltage value of the upstream switch Fi.

Similarly to the first embodiment, by executing the computer program P, the processing element of the control unit 33 executes the write processing, the transmission processing, the downstream switch control processing, load E1 power supply control processing, and the like. By executing the computer program P, the processing element of the control unit 33 also executes load Ei power supply control processing. The load Ei power supply control processing is processing for controlling the supply of power to the load Ei. The control unit 33 executes power supply control processing with respect to each of the n loads E1, E2, . . . , En. The transmission processing is different from the processing regarding control of the supply of power to the loads E1, E2, . . . , En.

When the control unit 33 includes two or more processing elements, the processing elements included in the control unit 33 may execute the write processing, the transmission processing, the downstream switch control processing, the load E1, E2, . . . , En power supply control processing, and the like in cooperation with each other.

### Load Ei Power Supply Control Processing

When the downstream switch Ga is ON, the control unit 33 executes the load Ei power supply control processing in a manner similar to the load E1 power supply control processing. For example, in the description of the load E1 power supply control processing, the load E1, the upstream switch F1, the drive circuit K1, the first output unit T1, and the A/D conversion unit X1 can be respectively replaced with the load Ei, the upstream switch Fi, the drive circuit Ki, the first output unit Ti, and the A/D conversion unit Xi. This thus obtains a description of the load Ei power supply control processing. If the source voltage value of the upstream switch Fi is greater than or equal to the voltage threshold value while the downstream switch Ga is ON and the upstream switch Fi has been instructed to switch OFF, the control unit 33 detects the occurrence of a short-circuit failure in the upstream switch Fi.

After executing step S37 during the power supply control processing performed with respect to one of the loads E1, E2, . . . , En, the control unit 33 ends the power supply control processing performed with respect to the other loads. In step S37, the control unit 33 instructs the second output unit U to switch OFF the downstream switch Ga. The control unit 33 does not execute the power supply control processing with respect to the loads E1, E2, . . . , En again.

As described above, the control unit 33 executes the power supply control processing with respect to the loads E1, E2, . . . , En. Accordingly, the control unit 33 gives instructions to switch each of the n upstream switches F1, F2, . . . , Fn ON or OFF. While an OFF switch instruction has been given for one of the n upstream switches F1, F2, . . . , Fn, the control unit 33 determines whether or not current is flowing through the upstream switch that received the OFF switch instruction. In the case of determining that current is flowing through the upstream switch that received the OFF switch instruction, the control unit 33 instructs the second output unit U to switch OFF the downstream switch Ga.

### Effects of ECU 12

With the ECU 12 according to the fourth embodiment, the supply of power to the n loads E1, E2, . . . , En can be stopped by the second output unit U of the microcomputer 21 switching OFF the downstream switch Ga. The ECU 12 of the fourth embodiment achieves effects similar to those of the ECU 12 of the first embodiment.

### Variations of Fourth Embodiment

In the ECU 12 of the fourth embodiment, the downstream switch Gb may be provided upstream or downstream of the downstream switch Ga, similarly to the second embodiment or the third embodiment. In this case, even if the connection state of the DC power supply 10 is the reverse connection state, as long as the two downstream switches Ga and Gb are OFF, current does not flow through the parasitic diodes Ja and Jb.

### FIFTH EMBODIMENT

In the first embodiment, the control unit 33 of the microcomputer 21 uses the source voltage value of the upstream switch F1 as a basis when determining whether or not current is flowing through the upstream switch F1. However, the value used to determine whether or not current is flowing through the upstream switch F1 is not limited to being the source voltage value of the upstream switch F1.

The following describes aspects of a fifth embodiment that are different from the first embodiment. Configurations other than those described below are the same as in the first embodiment, and therefore constituent elements that are the same as in the first embodiment are denoted by the same reference numerals as in the first embodiment and will not be described.

### Configuration of ECU 12

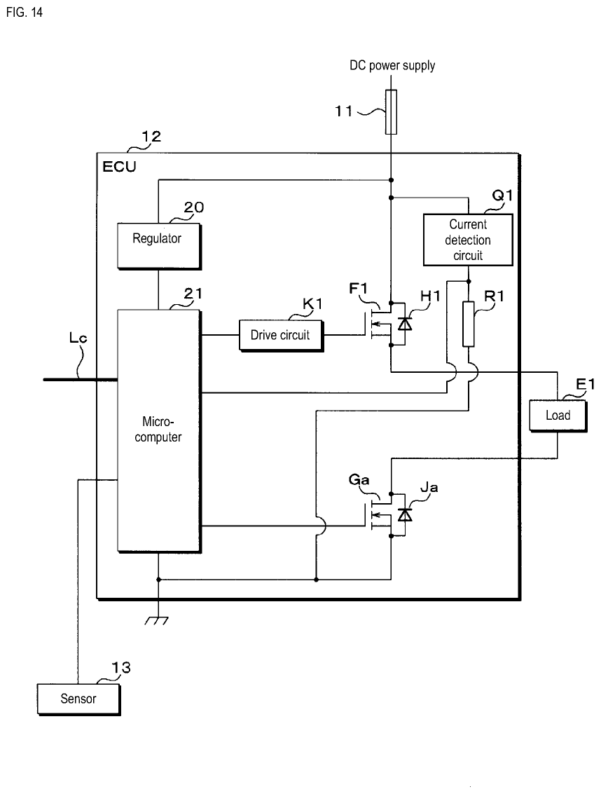

FIG. 14 is a block diagram showing the configuration of a relevant portion of the ECU 12 according to the fifth embodiment. The ECU 12 of the fifth embodiment includes constituent elements similar to those of the ECU 12 of the first embodiment, with the exception of the voltage detection circuit M1. The ECU 12 of the fifth embodiment further includes a current output circuit Q1 and a resistor R1. The current output circuit Q1 is connected to the drain of the upstream switch F1 and one end of the resistor R1. The other end of the resistor R1 is grounded. A connection node between the current output circuit Q1 and the resistor R1 is connected to the A/D conversion unit X1 of the microcomputer 21.

The current output circuit Q1 draws current from the drain of the upstream switch F1, and outputs the drawn current to the resistor R1. The current value of the current flowing through the upstream switch F1 will be referred to as the switch current value. The current value of the current output by the current output circuit Q1 to the resistor R1 will be referred to as the resistor current value. The current output circuit Q1 adjusts the resistor current value to (switch current value)/(predetermined number). The predetermined number is 1000, for example.

The voltage value across the resistor R1 is expressed by (switch current value)·(resistance value of resistor R1)/(predetermined number). The mark “·” indicates multiplication. The resistance value of the resistor R1 and the predetermined number are constant values. Therefore, the voltage value across the resistor R1 is analog current value information indicating the switch current value. The current value information is output to the A/D conversion unit X1 of the microcomputer 21.

### Configuration of Microcomputer 21

The A/D conversion unit X1 of the microcomputer 21 converts analog current value information received from the connection node between the current output circuit Q1 and the resistor R1 into digital current value information. The control unit 33 acquires the digital current value information obtained by the A/D conversion unit X1. The acquisition of the current value information corresponds to the acquisition of the switch current value.

### Power Supply Control Processing

In step S35 of the power supply control processing, the control unit 33 of the microcomputer 21 acquires current value information from the A/D conversion unit X1. The switch current value indicated by the current value information acquired by the control unit 33 substantially matches the switch current value at the time of acquisition. In step S36 of the power supply control processing, if the switch current value indicated by the current value information acquired in step S35 is zero A, the control unit 33 determines that current is not flowing through the upstream switch F1. If the switch current value indicated by the current value information acquired in step S35 exceeds zero A, the control unit 33 determines that current is flowing through the upstream switch F1.

### Effects of ECU 12

The ECU 12 of the fifth embodiment achieves effects similar to those of the ECU 12 of the first embodiment.

### Variations of Fifth Embodiment

The configuration for detecting the current value of the current flowing through the upstream switch F1 is not limited to being a configuration that uses the current output circuit Q1, but rather may be a configuration that uses a shunt resistor, for example. In this case, a shunt resistor is arranged between the source of the upstream switch F1 and the upstream end of the load E1. The resistance value of the shunt resistor is a constant value. For this reason, the voltage value across the shunt resistor is analog current value information indicating the switch current value. The current value information is input to the A/D conversion unit X1. In the ECU 12 of the fifth embodiment, the downstream switch Gb may be provided upstream or downstream of the downstream switch Ga, similarly to the second embodiment or the third embodiment.

### Variations of First to Fifth Embodiments

In the second and third embodiments, instead of using voltage value information, current value information may be used to determine whether or not current is flowing through the upstream switch F1, similarly to the fifth embodiment. In the fourth embodiment, for at least one of the n upstream switches F1, F2, . . . , Fn, the determining regarding whether or not current is flowing may be made using current value information instead of voltage value information.

In the first to third embodiments and the fifth embodiment, two upstream switches may be arranged upstream of the load El. In this case, the connections of the two upstream switches are similar to the connections of the two downstream switches Ga and Gb in the second embodiment or the third embodiment. If two upstream switches are used, the downstream switch Gb may be omitted. Similarly, in the fourth embodiment, two upstream switches may be arranged upstream of each the loads. In this case as well, the connections of the two upstream switches are similar to the connections of the two downstream switches Ga and Gb in the second embodiment or the third embodiment. If two upstream switches are provided on the upstream side of each of the loads, the downstream switch Gb may be omitted. If two upstream switches are provided upstream of the loads, the gates of the two upstream switches are connected to a common drive circuit. The drive circuit switches ON and OFF both of the upstream switches.

In the first embodiment, the control unit 33 of the microcomputer 21 gives an instruction to switch the upstream switch F1 ON or OFF while keeping the downstream switch Ga ON. The supply of power to the load E1 is thus controlled. However, the control unit 33 may give an instruction to switch the downstream switch Ga ON or OFF while keeping the upstream switch F1 ON. In this configuration, after giving the instruction to switch OFF the downstream switch Ga, the control unit 33 determines whether or not current is flowing through the downstream switch Ga. In the case of determining that current is flowing through the downstream switch Ga, the control unit 33 gives an instruction to switch OFF the upstream switch F1. In this case, the upstream switch F1 and the downstream switch Ga respectively function as the second switch and the first switch.

In this configuration, the current value of the current flowing through the downstream switch Ga is detected in the ECU 12. The control unit 33 determines whether or not current is flowing through the downstream switch Ga based on the current value of the current flowing through the downstream switch Ga. In the second, third, and fifth embodiments as well, the control unit 33 may give an instruction to switch ON of OFF the downstream switch Ga while keeping the upstream switch F1 ON. The control unit 33 detects a short-circuit failure in the downstream switch Ga.

When increasing the number of loads from 1 to n in a configuration for detecting the occurrence of a short-circuit failure in the downstream switch Ga, a common upstream switch and n downstream switches are used. One downstream switch is arranged downstream of each of the loads. In this case, the n downstream switches are controlled in a manner similar to the control of the n upstream switches F1, F2, . . . , Fn in the fourth embodiment. The common upstream switch is controlled in a manner similar to the control of the common downstream switch Ga in the fourth embodiment.

In the configuration for detecting a short-circuit failure in the downstream switch Ga as well, two downstream switches may be arranged on the downstream side of the load. Additionally, two upstream switches may be arranged upstream of the load.

In the first to fifth embodiments, the upstream switch is not limited to being an N-channel MOSFET, and may be another switch. Examples of other switches include a P-channel MOSFET, a FET other than a MOSFET, a bipolar transistor, and a relay contact. In the case of using a switch in which a parasitic diode is not formed, it is not necessary to connect the two upstream switches in series.

Similarly, in the first to fifth embodiments, the downstream switch is not limited to being an N-channel MOSFET, and may be another switch. Examples of other switches include a P-channel MOSFET, a FET other than a MOSFET, a bipolar transistor, and a relay contact. In the case of using a switch in which a parasitic diode is not formed, it is not necessary to connect the two downstream switches in series.

In the first to fifth embodiments, the number of sensors 13 connected to the microcomputer 21 of the ECU 12 is not limited to being one, and may be two or more. In this case, in both of steps S31 and S33 of the power supply control processing, the control unit 33 of the microcomputer 21 may use at least either communication data received by the communication unit 30 or sensor data received from a plurality of sensors 13. Processing not related to power supply control is not limited to being transmission processing, and may be processing different from transmission processing.

The technical features (constituent elements) described in the first to fifth embodiments can be combined with each other, and new technical features can be formed by such combinations.

The first to fifth embodiments disclosed herein should be considered illustrative in all respects and not restrictive. The scope of the present disclosure is indicated by the scope of the claims, not the meaning described above, and is intended to include meanings equivalent to the scope of the claims and all changes within the scope.

1. A power supply control device that controls a supply of power to a load, comprising:
an upstream switch configured to be arranged upstream of the load in a current path of a flow of current through the load;
a downstream switch configured to be arranged downstream of the load in the current path; and
a processing unit configured to execute processing,
wherein the processing unit gives an instruction to switch ON or OFF a first switch that is either one of the upstream switch and the downstream switch,
the processing unit determines whether or not current is flowing through the first switch while an instruction to switch OFF the first switch has been given, and
in a case of determining that current is flowing through the first switch, the processing unit gives an instruction to switch OFF a second switch that is another one of the upstream switch and the downstream switch.

2. The power supply control device according to claim 1,
wherein the current path is a path of current output from a fuse,
the processing unit receives a supply of power from a connection node between the fuse and the upstream switch, and
the processing unit executes transmission processing for transmitting data to an external device.

3. The power supply control device according to claim 1,
wherein the processing unit gives an instruction to switch ON or OFF the upstream switch,
the processing unit determines whether or not current is flowing through the upstream switch while an instruction to switch OFF the upstream switch has been given, and
in a case of determining that current is flowing through the upstream switch, the processing unit gives an instruction to switch OFF the downstream switch.

4. The power supply control device according to claim 3,
wherein the processing unit acquires a voltage value of a downstream end of the upstream switch while the instruction to switch OFF the upstream switch has been given, and
in a case where the acquired voltage value is greater than or equal to a voltage threshold value, the processing unit determines that current is flowing through the upstream switch.

5. The power supply control device according to claim 3,
wherein the power supply control device includes two of the downstream switches,
the two downstream switches are each a semiconductor switch,
a parasitic diode is connected across each of the two downstream switches, and
an anode of the parasitic diode of one of the downstream switches is connected to an anode of the parasitic diode of another one of the downstream switches.

6. The power supply control device according to claim 3,
wherein the power supply control device includes two of the downstream switches,
the two downstream switches are each a semiconductor switch,
a parasitic diode is connected across each of the two downstream switches, and
a cathode of the parasitic diode of one of the downstream switches is connected to a cathode of the parasitic diode of another one of the downstream switches.

7. The power supply control device according to claim 3,
wherein a plurality of loads are respectively arranged in current paths of a plurality of currents,
the power supply control device includes two of the upstream switches,
in each of the current paths, the upstream switch is arranged upstream of the load in the current path,
the plurality of currents flow through a common downstream switch,
the processing unit gives instructions to switch ON or OFF each of the upstream switches,
while having given an instruction to switch OFF one upstream switch among the plurality of upstream switches, the processing unit determines whether or not current is flowing through the one upstream switch for which the switch OFF instruction was given, and
in a case of determining that current is flowing through the one upstream switch for which the switch OFF instruction was given, the processing unit gives an instruction to switch OFF the downstream switch.

8. A power supply control method of controlling a supply of power to a load, the power supply control method causing a computer to execute the steps of:
giving an instruction to switch ON or OFF a first switch that is either one of an upstream switch arranged upstream of the load in a current path of a flow of current through the load and a downstream switch arranged downstream of the load in the current path;
determining whether or not current is flowing through the first switch while an instruction to switch OFF the first switch has been given; and
giving an instruction to switch OFF a second switch that is another one of the upstream switch and the downstream switch in a case where a determination was made that current is flowing through the first switch.

9. The power supply control device according to claim 2,
wherein the processing unit gives an instruction to switch ON or OFF the upstream switch,
the processing unit determines whether or not current is flowing through the upstream switch while an instruction to switch OFF the upstream switch has been given, and
in a case of determining that current is flowing through the upstream switch, the processing unit gives an instruction to switch OFF the downstream switch.

10. The power supply control device according to claim 4,
wherein the power supply control device includes two of the downstream switches,
the two downstream switches are each a semiconductor switch,
a parasitic diode is connected across each of the two downstream switches, and
an anode of the parasitic diode of one of the downstream switches is connected to an anode of the parasitic diode of another one of the downstream switches.

11. The power supply control device according to claim 4,
wherein the power supply control device includes two of the downstream switches,
the two downstream switches are each a semiconductor switch,
a parasitic diode is connected across each of the two downstream switches, and
a cathode of the parasitic diode of one of the downstream switches is connected to a cathode of the parasitic diode of another one of the downstream switches.

12. The power supply control device according to claim 4,
wherein a plurality of loads are respectively arranged in current paths of a plurality of currents,
the power supply control device includes two of the upstream switches,
in each of the current paths, the upstream switch is arranged upstream of the load in the current path,
the plurality of currents flow through a common downstream switch,
the processing unit gives instructions to switch ON or OFF each of the upstream switches,
while having given an instruction to switch OFF one upstream switch among the plurality of upstream switches, the processing unit determines whether or not current is flowing through the one upstream switch for which the switch OFF instruction was given, and
in a case of determining that current is flowing through the one upstream switch for which the switch OFF instruction was given, the processing unit gives an instruction to switch OFF the downstream switch.

13. The power supply control device according to claim 5,
wherein a plurality of loads are respectively arranged in current paths of a plurality of currents,
the power supply control device includes two of the upstream switches,
in each of the current paths, the upstream switch is arranged upstream of the load in the current path,
the plurality of currents flow through a common downstream switch,
the processing unit gives instructions to switch ON or OFF each of the upstream switches,
while having given an instruction to switch OFF one upstream switch among the plurality of upstream switches, the processing unit determines whether or not current is flowing through the one upstream switch for which the switch OFF instruction was given, and
in a case of determining that current is flowing through the one upstream switch for which the switch OFF instruction was given, the processing unit gives an instruction to switch OFF the downstream switch.

14. The power supply control device according to claim 6,
wherein a plurality of loads are respectively arranged in current paths of a plurality of currents,
the power supply control device includes two of the upstream switches,
in each of the current paths, the upstream switch is arranged upstream of the load in the current path,
the plurality of currents flow through a common downstream switch,
the processing unit gives instructions to switch ON or OFF each of the upstream switches,
while having given an instruction to switch OFF one upstream switch among the plurality of upstream switches, the processing unit determines whether or not current is flowing through the one upstream switch for which the switch OFF instruction was given, and
in a case of determining that current is flowing through the one upstream switch for which the switch OFF instruction was given, the processing unit gives an instruction to switch OFF the downstream switch.
